(19) United States
(12) Patent Application Publication
(10) Pub. No.: US 2016/0244666 A1
(43) Pub. Date: Aug. 25, 2016

(54) PHOSPHORESCENT MASTERBATCH AND FIBER

(71) Applicant: TAIWAN TEXTILE RESEARCH INSTITUTE, New Taipei City (TW)

(72) Inventors: Wei-Jen Lai, New Taipei City (TW); Huang-Chin Hung, New Taipei City (TW); Su-Chen Chen, New Taipei City (TW)

(21) Appl. No.: 15/008,556

(22) Filed: Jan. 28, 2016

(30) Foreign Application Priority Data
Feb. 25, 2015 (TW) 104106077

(51) Int. Cl. C09K 11/77

(52) U.S. Cl. CPC C09K 11/7792

(57) ABSTRACT

A phosphorescent masterbatch includes 1 to 50 parts by weight of a phosphorescent material, 43 to 98.8 parts by weight of a thermoplastic polymer, 0.1 to 5 parts by weight of a dispersing agent, and 0.1 to 2 parts by weight of a nucleating agent, which increases crystallization rate and thermal crystallization temperature of the thermoplastic polymer.

### RELATED APPLICATIONS

This application claims priority to Taiwan Application Serial Number 104106077, filed Feb. 25, 2015, which is herein incorporated by reference.

### BACKGROUND

1. Field of Invention

The present invention relates to a phosphorescent masterbatch and fiber, especially a phosphorescent masterbatch having high luminous intensity and a fiber manufactured by the phosphorescent masterbatch.

2. Description of Related Art

A phosphorescent material is generally applied to prepare phosphorescent objects, which may emit light after absorbing ultraviolet radiation or the like, and the light is also known as afterglow. After removing the external stimulus, the light could be visually observed for a time, which is known as afterglow time.

In some applications, the phosphorescent material and a thermoplastic polymer are jointly blended to manufacture a phosphorescent masterbatch. Generally, numerous phosphorescent material is required to increase luminous intensity of the phosphorescent masterbatch or the phosphorescent objects prepared by the phosphorescent masterbatch. However, a mechanical strength of the phosphorescent masterbatch is decreased when increasing the content of the phosphorescent material. Therefore, the textile-related applications usually face a problem of difficult spinning and machine-shaping since the masterbatch containing a high concentration of the phosphorescent material.

In view of the foregoing, there is a need in the related art to provide a method to increase luminous intensity of the phosphorescent masterbatch, so that to decrease the content of the phosphorescent material and maintain excellent luminous intensity and afterglow characteristic of the phosphorescent masterbatch.

### SUMMARY

The present disclosure provides a phosphorescent masterbatch, which includes 1 to 50 parts by weight of a phosphorescent material, 43 to 98.8 parts by weight of a thermoplastic polymer, 0.1 to 5 parts by weight of a dispersing agent, and 0.1 to 2 parts by weight of a nucleating agent, which increases crystallization rate and thermal crystallization temperature of the thermoplastic polymer.

In various embodiments of the present disclosure, a size of the phosphorescent material is in a range from 3 to 100 μm.

In various embodiments of the present disclosure, the phosphorescent masterbatch is an aluminate or a silicate.

In various embodiments of the present disclosure, the aluminate has a formula of (M1Al₂O₄:Eu, M2), where M1 is Mg, Ca, Sr or Ba, and M2 is Y, La, Ce, Pr, Nd, Sm, Gd, Tb, Dy, Ho, Er, Tm, Yb or Lu.

In various embodiments of the present disclosure, the silicate has a formula of (M3SiO₄:Eu, M4), where M3 is Mg, Ca, Sr or Ba, and M4 is Y, La, Ce, Pr, Nd, Sm, Gd, Tb, Dy, Ho, Er, Tm, Yb or Lu.

In various embodiments of the present disclosure, the thermoplastic polymer includes ethylene vinyl acetate (EVA), polyethylene (PE), polypropylene (PP), polyethylene terephthalate (PET), polybutylene terephthalate (PBT), thermoplastic elastomer (TPE), thermoplastic polyether ester elastomer (TPEE), Nylon 6, Nylon 6,6, or a combination thereof.

In various embodiments of the present disclosure, the dispersing agent is a wax polymer.

In various embodiments of the present disclosure, the wax polymer includes paraffin oil, bistearylethylenediamide wax, N, N′-ethylenebis(lauramide) wax, polyester wax, polyamide wax, or combinations thereof.

In various embodiments of the present disclosure, the dispersing agent includes maleic anhydride grafted polyethylene or maleic anhydride grafted polypropylene.

In various embodiments of the present disclosure, the dispersing agent includes silane-based coupling agent, titanium-based coupling agent or combinations thereof.

In various embodiments of the present disclosure, the nucleating agent increases crystallization temperature of the thermoplastic polymer of about 1° C. to 20° C.

In various embodiments of the present disclosure, the nucleating agent includes alkali carboxylate, alkaline carboxylate, aromatic carboxylate, sorbitol derivative, metal carboxylate, organic phosphate, abietic acid, ethylene-methyacrylic acid ionomer.

In various embodiments of the present disclosure, the sorbitol derivative is 1,3:2,4-bis-O-(3,4-dimethylbenzylidene)-D-sorbitol (DMDBS).

In various embodiments of the present disclosure, the organic phosphate is sodium 2,2′-methylenebis-(4,6-di-tert-butylphenyl) phosphate.

Another aspect of the present disclosure provides a phosphorescent fiber, which includes a core layer and a sheath layer. The core layer is made of a phosphorescent masterbatch, which includes 1 to 50 parts by weight of a phosphorescent material, 43 to 98.8 parts by weight of a thermoplastic polymer, 0.1 to 5 parts by weight of a dispersing agent, and 0.1 to 2 parts by weight of a nucleating agent. The sheath layer encapsulates the core layer, and a weight ratio between the core layer and the sheath layer is in a range from 10:90 to 90:10.

In various embodiments of the present disclosure, the sheath layer includes polyester, polyolefin, polyamide or combinations thereof.

### BRIEF DESCRIPTION OF THE DRAWINGS

The invention can be more fully understood by reading the following detailed description of the embodiment, with reference made to the accompanying drawings as follows:

FIG. 1 illustrates a differential scanning calorimetry (DSC) pattern of Comparative Example a1.

FIG. 2 illustrates a DSC pattern of Experimental Example A1.

FIG. 3 illustrates a DSC pattern of Comparative Example fol.

FIG. 4 illustrates a DSC pattern of Experimental Example B1.

FIG. 5 illustrates a DSC pattern of Experimental Example B2.

FIG. 6 illustrates a DSC pattern of Experimental Example B3.

FIG. 7 illustrates a DSC pattern of Experimental Example B4.

FIG. 8 illustrates a DSC pattern of Comparative Example c1.

FIG. 9 illustrates a DSC pattern of Experimental Example C1.

### DETAILED DESCRIPTION

The following disclosure provides many different embodiments, or examples, for implementing different features of the provided subject matter. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The present disclosure provides a phosphorescent masterbatch, which includes a phosphorescent material, a thermoplastic polymer, a dispersing agent and a nucleating agent, and embodiments and contents of the above constituents are described below.

When the phosphorescent material is excited by an energy (for example, light or heat), electrons of the phosphorescent material are elevated from a ground state to an excited state to store the energy, and these excited electrons return to the ground state and release the energy in the form of light. The phosphorescent material has characteristics of zero radiation, and may emit light over a long period after temporarily absorbing energy. The phosphorescent material may be an aluminate or a silicate, but not limited thereto. In some embodiments, the phosphorescent material is the aluminate doped by rare earth element, which has a formula of (M1Al₂O₄:Eu, M2), where M1 is Mg, Ca, Sr or Ba, and M2 is Y, La, Ce, Pr, Nd, Sm, Gd, Tb, Dy, Ho, Er, Tm, Yb or Lu. In various embodiments, the phosphorescent material is the silicate doped by rare earth element, which has a formula of (M3SiO₄:Eu, M4), where M3 is Mg, Ca, Sr or Ba, and M4 is Y, La, Ce, Pr, Nd, Sm, Gd, Tb, Dy, Ho, Er, Tm, Yb or Lu.

Based on 100 parts by weight of the phosphorescent masterbatch, the phosphorescent material is in a range from 1 to 50 parts by weight. In some embodiments, the phosphorescent material is in a range from 10 to 30 parts by weight. In some other embodiments, the phosphorescent material is in a range from 15 to 25 parts by weight. In addition, a size of the phosphorescent material is in a range from 3 to 100 g m. In some embodiments, an avenge size of the phosphorescent material is in a range from 8 to 20 μm.

The thermoplastic polymer includes ethylene vinyl acetate (EVA), polyethylene (PE), polypropylene (PP), polyethylene terephthalate (PET), polybutylene terephthalate (PBT), thermoplastic elastomer (TPE), thermoplastic polyether ester elastomer (TPEE), Nylon 6, Nylon 6,6, or combinations thereof. Based on 100 parts by weight of the phosphorescent masterbatch, the thermoplastic polymer is in a range from 43 to 98.8 parts by weight. In some embodiments, the thermoplastic polymer is in a range from 63 to 89.8 parts by weight. In some other embodiments, the thermoplastic polymer is in a range from 68 to 84.8 parts by weight.

The dispersing agent may assist in uniform distribution of the constituents within the composition, so as to enhance the whiteness and transparency of the thermoplastic polymer. Based on 100 parts by weight of the phosphorescent masterbatch, the dispersing agent is in a range from 0.1 to 5 parts by weight. In some embodiments, the dispersing agent is a wax polymer, such as paraffin oil, bistearylethylenediamide wax, N, N′-ethylenebis(lauramide) wax, polyester wax, polyamide wax, or combinations thereof. In various embodiments, the dispersing agent includes maleic anhydride grafted polyethylene or maleic anhydride grafted polypropylene. In some other embodiments, the dispersing agent includes silane-based coupling agent, titanium-based coupling agent or combinations thereof.

The phosphorescent masterbatch of the present disclosure includes nucleating agent to increase crystallization points in the thermoplastic polymer, and thus increases a crystallization rate and a crystallization temperature of the thermoplastic polymer. Based on 100 parts by weight of the phosphorescent masterbatch, the nucleating agent is in a range from 0.1 to 2 parts by weight. Specifically, the thermoplastic polymer is heated to a molten state during the preparation of the phosphorescent masterbatch, and the constituents are uniformly mixed within the molten thermoplastic polymer to form a mixture. After that, the mixture is cooled to form the phosphorescent masterbatch. However, slow crystallization rate in the cooling process will cause large crystal size of the thermoplastic polymer, and thus shields the phosphorescent material and decreases the transparency of the phosphorescent masterbatch.

Relatively, the nucleating agent is required to provide crystal nucleus for the crystallization of the thermoplastic polymer. Therefore, the thermoplastic polymer is easily to crystallize at the crystal nucleus in the cooling process, and thus increasing the crystallization rate and the crystallization temperature of the thermoplastic polymer. Described in different ways, the thermoplastic polymer is transformed from homogeneous nucleation to heterogeneous nucleation to refine the crystal size, and thereby significantly reducing the crystal size of the thermoplastic polymer. As such, the nucleating agent improves the transparency of the phosphorescent masterbatch to achieve higher luminous efficiency. In some embodiments, the nucleating agent increases the crystallization temperature of the thermoplastic polymer of about 1° C. to 20° C.

In some embodiments, the nucleating agent includess alkali carboxylate, alkaline carboxylate, aromatic carboxylate, sorbitol derivative, metal carboxylate, organic phosphate, abietic acid, ethylene-methyacrylic acid ionomer, but not limited thereto. In various embodiments, the sorbitol derivative is 1,3:2,4-bis-O-(3,4-dimethylbenzylidene)-D-sorbitol (DM DBS). In various embodiments, the organic phosphate is sodium 2,2′-methylenebis-(4,6-di-tert-butylphenyl) phosphate.

In some embodiments, the phosphorescent masterbatch further includes a crosslinking agent, but the present disclosure does not particularly limit the species of the crosslinking agent. It is worth noting that even if the crosslinking agent is not provided, the phosphorescent masterbatch prepared in accordance with above embodiments still maintain excellent luminous intensity and afterglow characteristic.

Various embodiments and parts by weight of the constituents of the phosphorescent masterbatch are described above, and methods and steps of preparing the phosphorescent masterbatch in accordance with various embodiments are described hereinafter.

### Embodiment 1

In Embodiment 1, the phosphorescent material is an aluminate having a formula of SrAl₂O₄:Eu,Dy, and an average size of the phosphorescent material is in a range from 8 to 20 μm. In addition, the thermoplastic polymer is polypropylene, the dispersing agent is bistearylethylenediamide wax, and the nucleating agent is 1,3:2,4-bis-O-(3,4-dimethylbenzylidene)-D-sorbitol. Refer to Table 1, which lists parts by weigh of each constituents in Experimental Example and Comparative Example of Embodiment 1, based on 100 parts by weight of the phosphorescent masterbatch.

TABLE 1
parts by weight of each constituent in phosphorescent
masterbatch of Embodiment 1.

| | thermoplastic | phosphorescent | dispersing | nucleating |
|---|---|---|---|---|
| | polymer | material | agent | agent |
| | (parts by | (parts by | (parts by | (parts by |
| | weight) | weight) | weight) | weight) |
| Comparative | 79 | 20 | 1 | 0 |
| Example a1 | | | | |
| Experimental | 78.5 | 20 | 1 | 0.5 |
| Example A1 | | | | |

Then, the phosphorescent material, the thermoplastic polymer, the dispersing agent and the nucleating agent are mixed to form a mixture, and any suitable container or mixing apparatus could be applied to perform the above step of mixing. After that, the mixture is fed into an extruder for blending to form the phosphorescent masterbatch. The thermoplastic polymer is polypropylene in Embodiment 1, so the blending temperature is between 175 and 195° C., and the blending time is between 0.5 and 10 minutes. During the blending process, the thermoplastic polymer in the constituents is heated to the molten state, and the remaining constituents are uniformly mixed within the molten thermoplastic polymer. Similarly, the phosphorescent material is uniformly dispersed in the thermoplastic polymer by the assistance of the dispersing agent and the extruder.

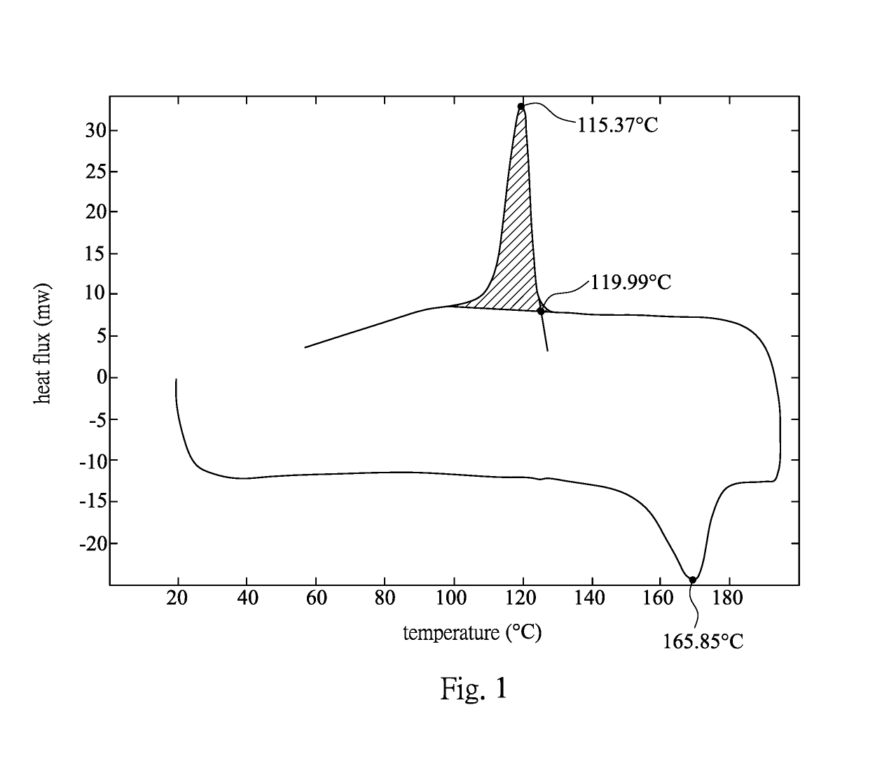

After blending, a cooling process and a granulating process is performed to prepare the phosphorescent masterbatch. Refer to FIG. 1, which illustrates a differential scanning calorimetry (DSC) pattern of Comparative Example a1. The DSC pattern includes an exothermic peak, which means that the mixture is gradually transformed from the molten state into a crystalline state. The exothermic peak is analyzed to find out a start crystallization temperature, a crystallization temperature, and a crystallization exothermic value. The temperature corresponding to the highest point of the exothermic peak is the crystallization temperature, and an area (shaded part) between the exothermic peak and a base line is the crystallization exothermic value. It is worth noting that a temperature between a melting point and the crystallization temperature is ΔT_{mc}, and small ΔT_{mc} shows that the molten mixture is easy to form crystal nucleus during the cooling process, and thus causes higher crystallization rate and crystallinity of the material.

As shown in FIG. 1, Comparative Example a1 without the nucleating agent starts to form crystallization at 119.99° C. and has a crystallization temperature of 115.37° C., a crystallization exothermic value of 82.3886 J/g, a melting point of 165.85° C. and ΔT_{mc} of 50.48° C.

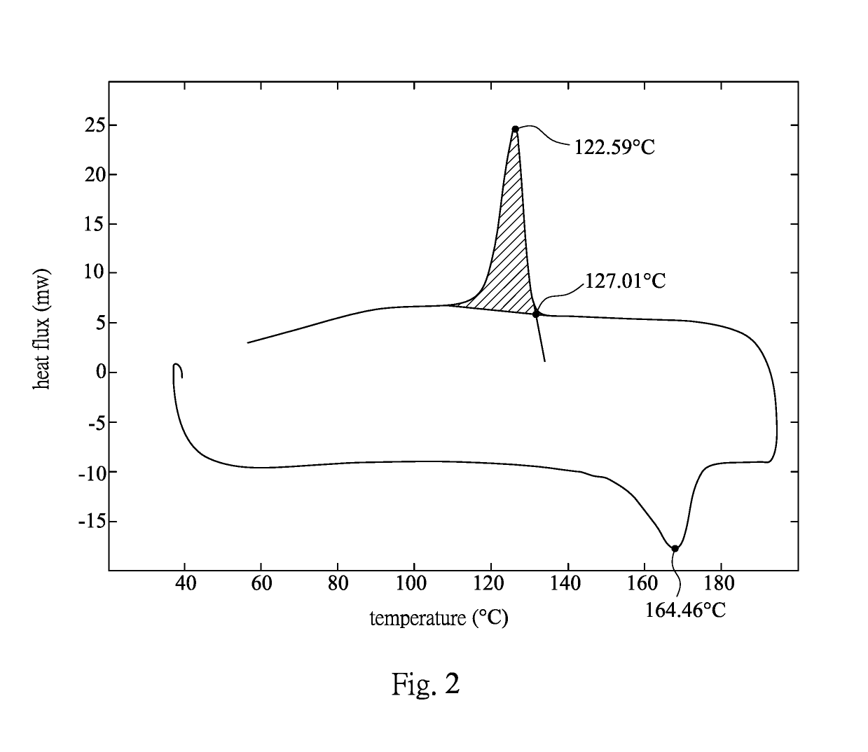

Refer to FIG. 2, which illustrates a DSC pattern of Experimental Example A1. As shown in FIG. 2, Experimental Example A1 having the nucleating agent starts to form crystallization at 127.01° C. and has a crystallization temperature of 122.59° C., which is obviously higher than the crystallization temperature (115.37° C.) of Comparative Example a1. In addition, Experimental Example A1 has a crystallization exothermic value of 74.2665 J/g, a melting point of 164. 46° C. and ΔT_{mc} of 41.87° C., which is lower than ΔT_{mc} (50.48° C.) of Comparative Example a1. Accordingly, the nucleating agent increases the crystallization temperature and decreases the ←T_{mc}, so as to achieve higher crystallization rate. Then, the granulating process is performed to form the particles of phosphorescent masterbatch.

The above phosphorescent masterbatch are subjected to analysis of luminous intensity of afterglow, and the analysis method is described below. Samples are irradiated by a standard illumination object D65 of the International Commission on Illumination (CIE) for about 20 minutes, and the samples are disposed in a darkroom to observe the Illumination from the samples. Every two minutes, the luminous intensity of each sample is measured and recorded, and the measurement is continuous for 120 minutes. In addition, a Lab color space of the phosphorescent masterbatch is analyzed. Table 2 lists Lab color space of the phosphorescent masterbatch and the luminous intensity thereof after 2 minutes and 10 minutes.

TABLE 2
Lab color space and the luminous intensity of
the phosphorescent masterbatch in Embodiment 1.

| | | Red-green | Yellow-blue | luminous intensity | |
|---|---|---|---|---|---|
| | lightness | value | value | (mcd/m²) | |
| | (L) | (a) | (b) | 2 mins | 10 mins |
| Comparative | 76.6 | −3.3 | 7.6 | 859 | 214 |
| Example a1 | | | | | |
| Experimental | 78.5 | −4.1 | 8.4 | 1063 | 270 |
| Example A1 | | | | | |

As shown in Table 2, Comparative Example a1 has 20 parts by weight of the phosphorescent material, and its luminous intensity of afterglow after 2 minutes is about 859 mcd/m², which is decreased to about 214 mcd/m² after 10 minutes. Relatively, Experimental Example A1 also has 20 parts by weight of the phosphorescent material, and its luminous intensity of afterglow after 2 minutes (about 1063 mcd/m²) and 10 minutes (about 270 mcd/m²) are both higher than that of Comparative Example a1. In addition, the lightness (78.5) of Experimental Example A1 is also higher than the lightness (76.6) of Comparative Example a1. Accordingly, when using the same parts by weight of the phosphorescent material, adding the nucleating agent increases the luminous intensity of the phosphorescent masterbatch. The nucleating agent is able to increase crystallizing points in the thermoplastic polymer to increase the crystallization rate and the crystallization temperature of the thermoplastic polymer during the cooling process. Therefore, the thermoplastic polymer will have smaller crystal size to avoid shielding the light from the phosphorescent material. In various embodiments, the parts by weight of the phosphorescent material in the phosphorescent masterbatch may be reduced, and the nucleating agent is added to maintain a certain luminous intensity of the phosphorescent masterbatch.

### Embodiment 2

In Embodiment 2, the phosphorescent material is an aluminate having a formula of SrAl₂O₄:Eu,Dy, and an average size of the phosphorescent material is in a range from 8 to 20 μm. In addition, the thermoplastic polymer is polyethylene terephthalate, the dispersing agent is micronized polyamide wax, and the nucleating agent is 2,2′-methylenebis-(4,6-di-tert-butylphenyl)phosphate. Referring to Table 3, which lists parts by weigh of each constituents in Experimental Example and Comparative Example of Embodiment 2, based on 100 parts by weight of the phosphorescent masterbatch.

TABLE 3
parts by weight of each constituent in phosphorescent
masterbatch of Embodiment 2.

| | thermoplastic | phosphorescent | dispersing | nucleating |
|---|---|---|---|---|
| | polymer | material | agent | agent |
| | (parts by | (parts by | (parts by | (parts by |
| | weight) | weight) | weight) | weight) |
| Comparative | 78 | 20 | 2 | 0 |
| Example b1 | | | | |
| Experimental | 77.5 | 20 | 2 | 0.5 |
| Example B1 | | | | |
| Experimental | 77 | 20 | 2 | 1 |
| Example B2 | | | | |
| Experimental | 76.5 | 20 | 2 | 1.5 |
| Example B3 | | | | |
| Experimental | 76 | 20 | 2 | 0.5 |
| Example B4 | | | | |

Then, the phosphorescent material, the thermoplastic polymer, the dispersing agent and the nucleating agent are mixed to form a mixture, and the mixture is fed into an extruder for blending to form the phosphorescent masterbatch. The thermoplastic polymer is polyethylene terephthalate in Embodiment 2, so the blending temperature is between 250 and 270° C., and the blending time is between 0.5 and 10 minutes. During the blending process, the thermoplastic polymer in the constituents is heated to the molten state, and the remaining constituents are uniformly mixed within the molten thermoplastic polymer.

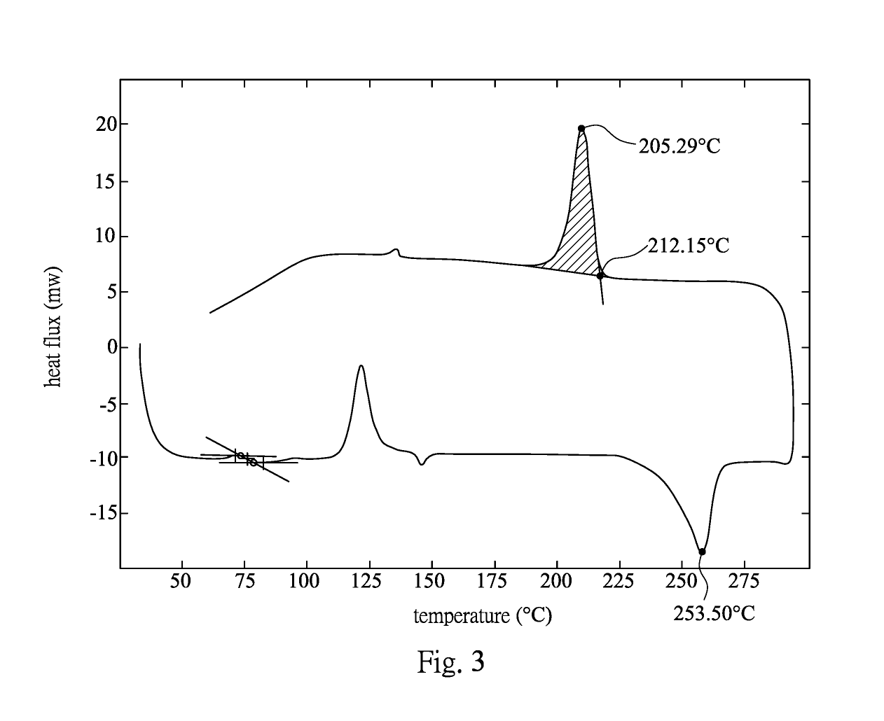

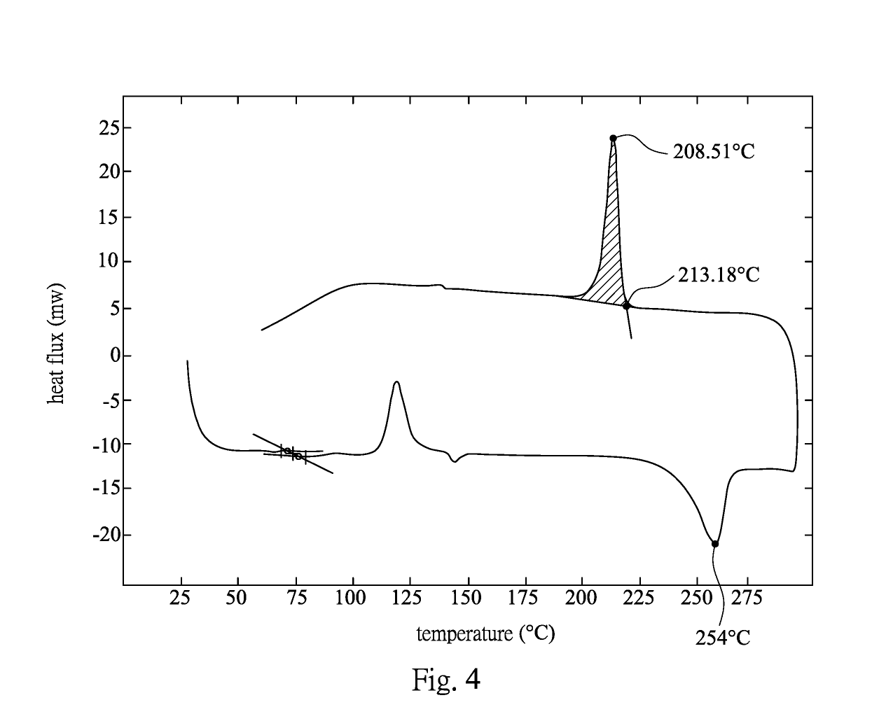

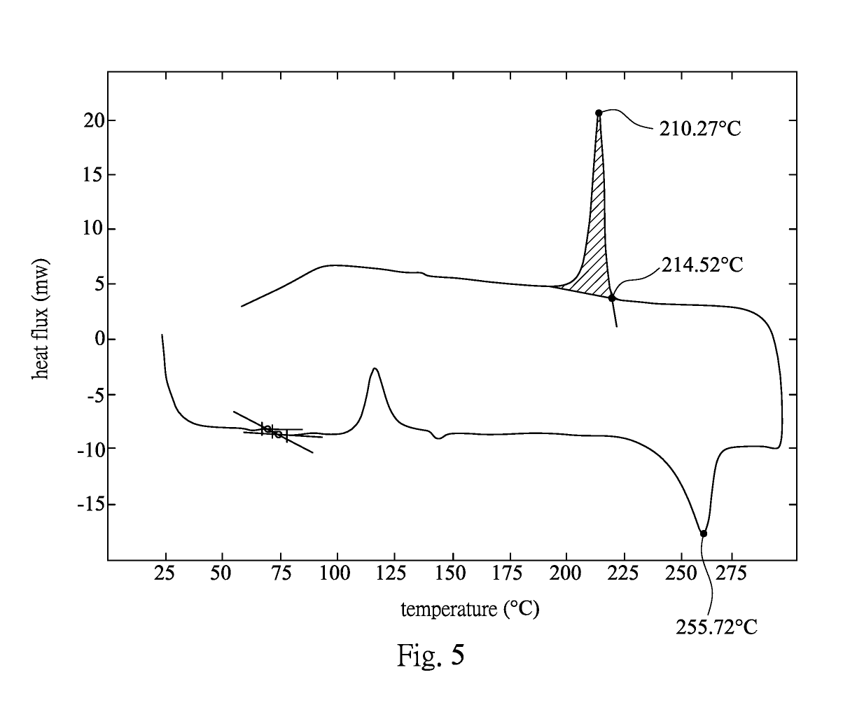

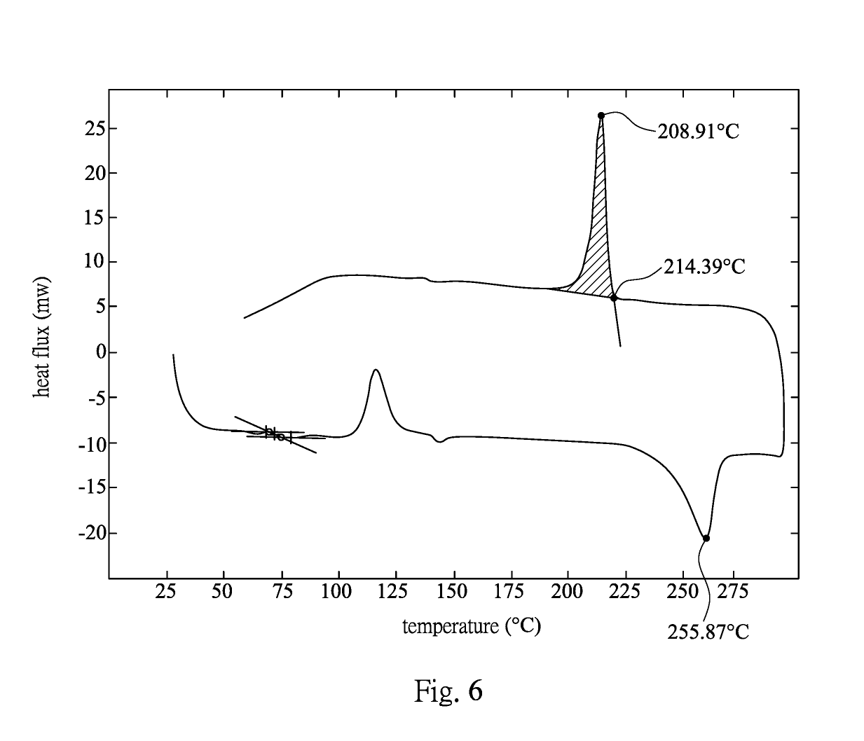

After blending, a cooling process and a granulating process is performed to the mixture to prepare the phosphorescent masterbatch. Refer to FIG. 3, which illustrates a DSC pattern of Comparative Example b1. As shown in FIG. 3, Comparative Example b1 without the nucleating agent starts to form crystallization at 212.15° C. and has a crystallization temperature of 205.29° C., a crystallization exothermic value of 34.4689 J/g, a melting point of 253.50° C. and ΔT_{mc} of 48.21° C. Continuing in FIGS. 4-7, which respectively illustrate DSC patterns of Experimental Examples B1-B4. As shown in FIGS. 4-7, Experimental Examples B1-B4 having the nucleating agent respectively start to form crystallization at 213.18° C., 214.52° C., 214.39° C. and 214.60° C. and respectively have crystallization temperatures of 208.51° C., 210.27° C., 208.91° C. and 210.15° C., all are higher than the crystallization temperature (205.29° C.) of Comparative Example b1. In addition, Experimental Examples B1-B4 respectively have crystallization exothermic values of 34.4654 J/g, 33.2381 J/g, 36.4399 J/g and 32.9889 J/g, and melting points of the Experimental Examples B1-B4 respectively are 245° C., 255.72° C., 255.87° C., 254.19° C., so the Experimental Examples B1-B4 respectively have ΔT_{mc} of 45.49° C., 45.45° C., 46.96° C., 44.04° C., all are lower than ΔT_{mc} (48.21° C.) of Comparative Example b1. Accordingly, the nucleating agent is able to increase the crystallization rate and the crystallization temperature. Then, the granulating process is performed to form the particles of phosphorescent masterbatch.

Continuing in Table 4, which lists Lab color space of the phosphorescent masterbatch and the luminous intensity thereof after 2 minutes and 10 minutes. The analysis method of the phosphorescent masterbatch is the same with Embodiment 1, and the details are not described herein.

TABLE 4
Lab color space and the luminous intensity of
the phosphorescent masterbatch in Embodiment 2.

| | | Red-green | Yellow-blue | luminous intensity | |
|---|---|---|---|---|---|
| | lightness | value | value | (mcd/m²) | |
| | (L) | (a) | (b) | 2 mins | 10 mins |
| Comparative | 67.2 | −5.5 | 11.9 | 572 | 145 |
| Example b1 | | | | | |
| Experimental | 68.5 | −3.9 | 13.9 | 613 | 158 |
| Example B1 | | | | | |
| Experimental | 70.7 | −2.2 | 12.8 | 716 | 186 |
| Example B2 | | | | | |
| Experimental | 70.9 | −3.4 | 15.1 | 701 | 183 |
| Example B3 | | | | | |
| Experimental | 71.2 | −2 | 16.4 | 635 | 165 |
| Example B4 | | | | | |

As shown in Table 4, Comparative Example b1 has 20 parts by weight of the phosphorescent material, and its luminous intensity of afterglow after 2 minutes is about 572 mcd/m², which is decreased to about 145 mcd/m² after 10 minutes. Relatively, Experimental Examples B1-B4 also have 20 parts by weight of the phosphorescent material, and the luminous intensity of afterglow after 2 minutes (about 613-716 mcd/m²) and 10 minutes (about 158-186 mcd/m²) are both higher than that of Comparative Example b1. In addition, the lightness (68.5-71.2) of Experimental Examples B1-B4 are also higher the lightness (67.2) of Comparative Example b1. Accordingly, when using the same parts by weight of the phosphorescent material, adding the nucleating agent increases the luminous intensity phosphorescent masterbatch.

It is worth noting that, even though the nucleating agent increases the luminous intensity of the phosphorescent masterbatch, but excess nucleating agent would cause high degree of crystallinity of the thermoplastic polymer, and thus decreases the transparency of the phosphorescent masterbatch and cannot reach the higher luminous intensity. In Experimental Examples B2, B3 and B4, the nucleating agent is respectively 1, 1.5, and 2 parts by weight. Refer to Table 4 at the same time, the luminous intensity of afterglow of Experimental Examples B2 (about 716 mcd/m² after 2 minutes, about 186 mcd/m² after 10 minutes) is higher than the luminous intensity of afterglow of Experimental Examples B3 (about 701 mcd/m² after 2 minutes, about 183 mcd/m² after 10 minutes), and the luminous intensity of afterglow of Experimental Examples B3 is further higher than the luminous intensity of afterglow of Experimental Examples B4 (about 635 mcd/m² after 2 minutes, about 165 mcd/m² after 10 minutes). Therefore, it is known that excess nucleating agent would cause high degree of crystallinity of the thermoplastic polymer, and thus decreases the luminous intensity of the phosphorescent masterbatch. Thus, the nucleating agent is controlled in a range from 0.1 to 2 parts by weight to sufficiently increase the luminous intensity of the phosphorescent masterbatch.

### Embodiment 3

In Embodiment 3, the phosphorescent material is an aluminate having a formula of SrAl₂O₄:Eu,Dy, and an average size of the phosphorescent material is in a range from 8 to 20 μm. In addition, the thermoplastic polymer is polybutylene terephthalate, and the nucleating agent is 2,2′-methylenebis-(4,6-di-tert-butylphenyl) phosphate. Comparing with Embodiments 1 and 2, Embodiment 3 further compares the luminous intensity of the phosphorescent masterbatch for using different dispersing agents. The dispersing agent in Comparative Example c1 and Experimental Example C1 is bistearylethylenediamide wax, and the dispersing agent in Comparative Example c2 is titanate coupling agent. Refer to Table 5, which lists parts by weigh of each constituents in Experimental Example and Comparative Example of Embodiment 3, based on 100 parts by weight of the phosphorescent masterbatch.

TABLE 5
parts by weight of each constituent in phosphorescent
masterbatch of Embodiment 3

| | thermoplastic | phosphorescent | dispersing | nucleating |
|---|---|---|---|---|
| | polymer | material | agent | agent |
| | (parts by | (parts by | (parts by | (parts by |
| | weight) | weight) | weight) | weight) |
| Comparative | 78 | 20 | 2 | 0 |
| Example c1 | | | | |
| Comparative | 79 | 20 | 1 | 0 |
| Example c2 | | | | |
| Experimental | 77.5 | 20 | 2 | 0.5 |
| Example C1 | | | | |

Then, the phosphorescent material, the thermoplastic polymer, the dispersing agent and the nucleating agent are mixed to form a mixture, and the mixture is fed into an extruder for blending to form the phosphorescent masterbatch. The thermoplastic polymer is polybutylene terephthalate in Embodiment 3, so the blending temperature is between 225 and 245° C., and the blending time is between 0.5 and 10 minutes. During the blending process, the thermoplastic polymer in the constituents is heated to the molten state, and the remaining constituents are uniformly mixed within the molten thermoplastic polymer to increase the crystallization temperature and achieve higher crystallization rate

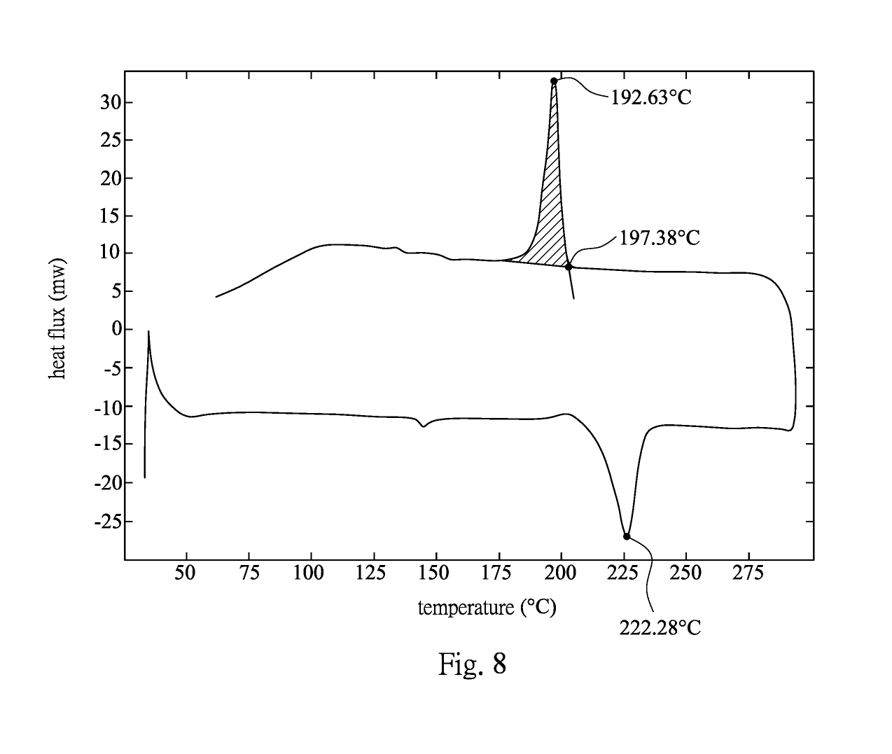

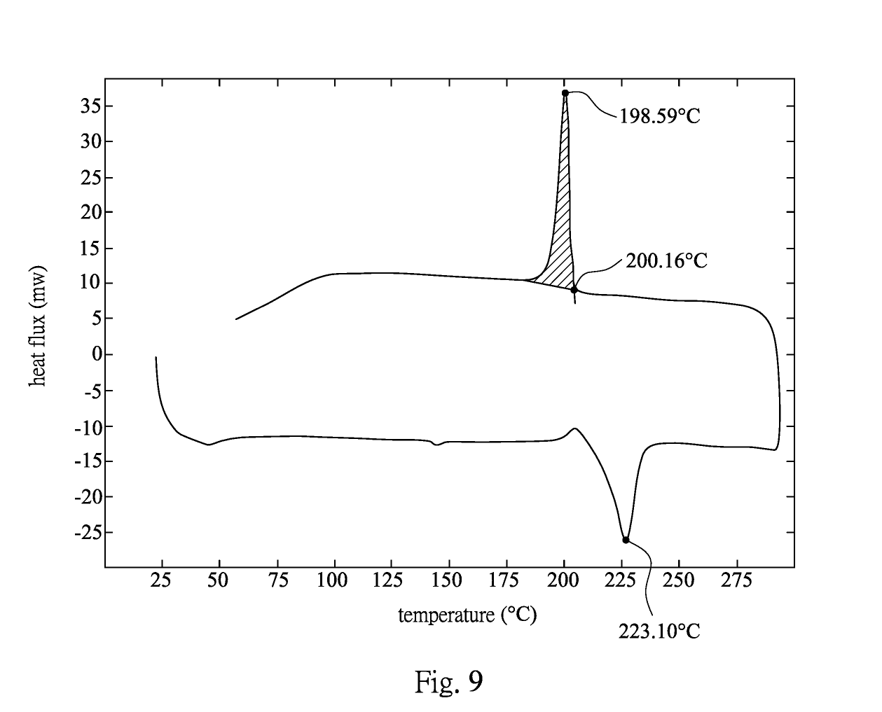

After blending, a cooling process and a granulating process is performed to the mixture to prepare the phosphorescent masterbatch. Refer to FIG. 8, which illustrates a DSC pattern of Comparative Example c1. As shown in FIG. 8, Comparative Example c1 without the nucleating agent starts to form crystallization at 197.38° C. and has a crystallization temperature of 192.63° C., a crystallization exothermic value of 39.4293 J/g, a melting point of 222.28° C. and ΔT_{mcc} of 29.65° C. Continuing to FIG. 9, which illustrates a DSC pattern of Experimental Example C1. As shown in FIG. 9, Experimental Example C1 having the nucleating agent starts to form crystallization at 200.16° C. and has a crystallization temperature of 198.59° C., which is higher than the crystallization temperature (192.63° C.) of Comparative Example c1. In addition, Experimental Example C1 has a crystallization exothermic value of 39.5623 J/g, a melting point of 223.10° C. and ΔT_{mc} of 24.51° C., which is lower than ΔT_{mc} (29.65° C.) of Comparative Example c1. Accordingly, the nucleating agent increases the crystallization temperature and the crystallization rate. Then, the granulating process is performed to form the particles of phosphorescent masterbatch.

Continuing in Table 6, which lists Lab color space of the phosphorescent masterbatch and the luminous intensity thereof after 2 minutes and 10 minutes. The analysis method of the phosphorescent masterbatch is the same with Embodiment 1, and the details are not described herein.

TABLE 6
Lab color space and the luminous intensity of
the phosphorescent masterbatch in Embodiment 3.

| | | Red-green | Yellow-blue | luminous intensity | |
|---|---|---|---|---|---|
| | lightness | value | value | (mcd/m²) | |
| | (L) | (a) | (b) | 2 mins | 10 mins |
| Comparative | 75.49 | −3.85 | 6.64 | 499 | 123 |
| Example c1 | | | | | |
| Comparative | 68.6 | −2.28 | 8.58 | 457 | 120 |
| Example c2 | | | | | |
| Experimental | 79.86 | −1.44 | 11.29 | 642 | 167 |
| Example B2 | | | | | |

Refer first to Comparative Examples c1 and c2, which both have 20 parts by weight of the phosphorescent material, but different dispersing agents are respectively used in Comparative Examples c1 and c2. As shown in Table 6, the luminous intensity of afterglow of Comparative Example c1 (about 499 mcd/m² after 2 minutes, about 123 mcd/m² after 10 minutes) is higher than the luminous intensity of afterglow of Comparative Example c2 (about 457 mcd/m² after 2 minutes, about 120 mcd/m² after 10 minutes), and Comparative Example c1 also has higher lightness. Thus, types of the dispersing agent also affect the luminous intensity of the phosphorescent masterbatch, so a suitable dispersing agent is chosen depending on different types of the phosphorescent material, the thermoplastic polymer and the nucleating agent.

In addition, Experimental Example C1 also has 20 parts by weight of the phosphorescent material, and its luminous intensity of afterglow after 2 minutes (about 642 mcd/m²) and 10 minutes (about 167 mcd/m²) are both higher than that of the Comparative Example c1. In addition, the lightness (79.86) of Experimental Example C1 is also higher the lightness (75.49) of Comparative Example c1. Embodiment 3 is similar with Embodiment 1, when using the same parts by weight of the phosphorescent material, adding the nucleating agent increases the luminous intensity of the phosphorescent masterbatch.

The phosphorescent masterbatch having the nucleating agent may be used to prepare a wide variety of phosphorescent objects, such as phosphorescent fiber, filament, yarn, textile, membrane, flake or chip. The present disclosure illustrates phosphorescent fiber as an example of the phosphorescent objects, but not limited thereto. It should be understood other phosphorescent objects could be used without affecting the spirit of the present disclosure.

Another aspect of the present disclosure provides a phosphorescent fiber, which includes a core layer and a sheath layer. The core layer is made of the aforementioned phosphorescent masterbatch, and the sheath layer encapsulates the core layer. A weight ratio between the core layer and the sheath layer is in a range from 10:90 to 90:10. The sheath layer includes polyester, polyolefin, polyimide or combinations thereof. Specifically, the sheath layer is made of a thermoplastic polymer, including aforementioned ethylene vinyl acetate(EVA), polyethylene(PE), polypropylene(PP), polyethylene terephthalate (PET), polybutylene terephthalate (PBT), thermoplastic elastomer (TPE), thermoplastic polyether ester elastomer (TPEE), Nylon 6, Nylon 6,6, or a combination thereof. Depending on different designs and purposes of the phosphorescent objects, the thermoplastic polymer of the phosphorescent masterbatch could be the same with or different from the thermoplastic polymer of the sheath layer.

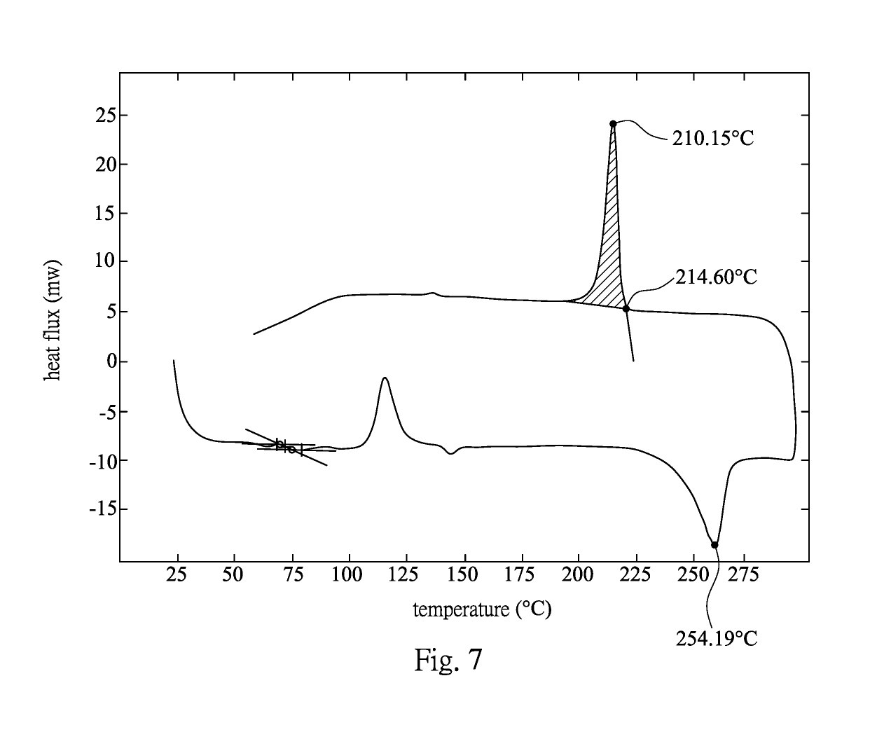

Then, the above phosphorescent masterbatchs of Comparative Example and Experimental Example are used to prepare the core layer of the phosphorescent fiber, and Nylon 6 and polybutylene terephthalate (PBT) are respectively used to prepare the sheath layer of the phosphorescent fiber. Then, a melt-spinning process is applied to form the core-sheath phosphorescent fiber, and the weight ratio between the core layer and the sheath layer is 50: 50. Refer to FIG. 7, which lists strength of the phosphorescent fiber and the luminous intensity thereof after 2 minutes and 10 minutes. The analysis method of the phosphorescent fiber is the same with Embodiment 1, and the details are not described herein.

TABLE 7
fiber strength and the luminous intensity
of the phosphorescent fiber

| | | fiber strength | luminous intensity | |
|---|---|---|---|---|
| core | sheath | (g/d)/variation | (mcd/m²) | |
| layer | layer | coefficient(%) | 2 mins | 10 mins |
| Comparative | Nylon 6 | 1.39/5.36 | 39 | 9 |
| Example a1 | | | | |
| Experimental | Nylon 6 | 1.4/3.17 | 42 | 9 |
| Example A1 | | | | |
| Comparative | PBT | 0.29/5.07 | 128 | 28 |
| Example c1 | | | | |
| Experimental | PBT | 0.37/3.38 | 155 | 34 |
| Example C1 | | | | |

As shown in FIG. 7, the core layer is respectively made of the phosphorescent masterbatch of Comparative Example a1 and Experimental Example A1, and the sheath layer is made of Nylon 6. After 2 minutes, the phosphorescent fiber prepared by Experimental Example A1 has luminous intensity of afterglow of about 42 mcd/m², and the phosphorescent fiber prepared by Comparative Example a1 has luminous intensity of afterglow of only about 39 mcd/m². After 10 minutes, the phosphorescent fibers of Experimental Example A1 and Comparative Example a1 both have luminous intensity of afterglow of about 9 mcd/m². In addition, the phosphorescent fiber prepared by Experimental Example A1 has higher fiber strength and smaller variation coefficient. Accordingly, adding the nucleating agent not only increases the luminous intensity of afterglow of the phosphorescent fiber, but also increases fiber strength thereof, so the phosphorescent fiber could be widely used in various fields.

Similarly, the core layer is respectively made of the phosphorescent masterbatchs of Comparative Example c1 and Experimental Example C1, and the sheath layer is made of polybutylene terephthalate. As shown in Table 7, the luminous intensity (about 155 mcd/m² after 2 minutes, about 34 mcd/m² after 10 minutes) of afterglow of the phosphorescent fiber prepared by Experimental Example C1 is higher than the luminous intensity (about 128 mcd/m² after 2 minutes, about 28 mcd/m² after 10 minutes) of afterglow of the phosphorescent fiber prepared by Comparative Example c1. In addition, the phosphorescent fiber prepared by Experimental Example C1 also has higher fiber strength and smaller variation coefficient, which means that adding the nucleating agent increases luminous intensity of afterglow and fiber strength of the phosphorescent fiber.

The embodiments of the present disclosure discussed above have various advantages, which are summarized below. The phosphorescent masterbatch of the present disclosure includes the nucleating agent to provide a plurality of crystal nucleus, and the thermoplastic polymer is crystallizing at these crystal nucleus, so as to increase the crystallization rate and the crystallization temperature of the thermoplastic polymer and reduce the crystal size of the thermoplastic polymer. As such, the light from the phosphorescent material is avoided to be shielded, so to achieve higher luminous intensity of the phosphorescent masterbatch. With the nucleating agent, the phosphorescent fiber prepared by the phosphorescent masterbatch of the present disclosure would achieve excellent luminous intensity and better fiber strength. On this base, the phosphorescent masterbatch and fiber of the present disclosure would show excellent luminous intensity even though having low content of the phosphorescent material, and thus simple spinning process and machine-shaping process could be applied to prepare a fiber having high mechanical strength. In addition, the phosphorescent masterbatch of the present disclosure is applied to prepare a phosphorescent textile having high luminous intensity, so as to improve sense of design, prompt facility and range of application of the textile.

Although the present invention has been described in considerable detail with reference to certain embodiments thereof, other embodiments are possible. Therefore, the spirit and scope of the appended claims should not be limited to the description of the embodiments contained herein. Reference will now be made in detail to the embodiments of the invention, examples of which are illustrated in the accompanying drawings. Wherever possible, the same reference numbers are used in the drawings and the description to refer to the same or like parts.

What is claimed is:

1. A phosphorescent masterbatch, comprising:
a phosphorescent material in a range from 1 to 50 parts by weight;
a thermoplastic polymer in a range from 43 to 98.8 parts by weight;
a dispersing agent in a range from 0.1 to 5 parts by weight; and
a nucleating agent in a range from 0.1 to 2 parts by weight, and the nucleating agent increasing crystallization rate and crystallization temperature of the thermoplastic polymer.

2. The phosphorescent masterbatch of claim 1, wherein a size of the phosphorescent material is in a range from 3 to 100 μm.

3. The phosphorescent masterbatch of claim 1, wherein the phosphorescent masterbatch is an aluminate or a silicate.

4. The phosphorescent masterbatch of claim 3, wherein the aluminate has a formula of (M1Al₂O₄:Eu, M2), where M1 is Mg, Ca, Sr or Ba, and M2 is Y, La, Ce, Pr, Nd, Sm, Gd, Tb, Dy, Ho, Er, Tm, Yb or Lu.

5. The phosphorescent masterbatch of claim 3, wherein the silicate has a formula of (M3SiO₄:Eu, M4), where M3 is Mg, Ca, Sr or Ba, and M4 is Y, La, Ce, Pr, Nd, Sm, Gd, Tb, Dy, Ho, Er, Tm, Yb or Lu.

6. The phosphorescent masterbatch of claim 1, wherein the thermoplastic polymer comprises ethylene vinyl acetate(EVA), polyethylene(PE), polypropylene(PP), polyethylene terephthalate (PET), polybutylene terephthalate (PBT), thermoplastic elastomer (TPE), thermoplastic polyether ester elastomer (TPEE), Nylon 6, Nylon 6,6, or a combination thereof.

7. The phosphorescent masterbatch of claim 1, wherein the dispersing agent is a wax polymer.

8. The phosphorescent masterbatch of claim 7, wherein the wax polymer comprises paraffin oil, bistearylethylenediamide wax, N, N′-ethylenebis(lauramide) wax, polyester wax, polyamide wax, or combinations thereof.

9. The phosphorescent masterbatch of claim 1, wherein the dispersing agent comprises maleic anhydride grafted polyethylene or maleic anhydride grafted polypropylene.

10. The phosphorescent masterbatch of claim 1, wherein the dispersing agent comprises silane-based coupling agent, titanium-based coupling agent or combinations thereof.

11. The phosphorescent masterbatch of claim 1, wherein the nucleating agent increases crystallization temperature of the thermoplastic polymer of 1° C. to 20° C.

12. The phosphorescent masterbatch of claim 1, wherein the nucleating agent comprises alkali carboxylate, alkaline carboxylate, aromatic carboxylate, sorbitol derivative, metal carboxylate, organic phosphate, abietic acid, ethylene-methyacrylic acid ionomer or combinations thereof.

13. The phosphorescent masterbatch of claim 12, wherein the sorbitol derivative is 1,3:2,4-bis-O-(3,4-dimethylbenzylidene)-D-sorbitol (DMDBS).

14. The phosphorescent masterbatch of claim 12, wherein the organic phosphate is sodium 2,2′-methylenebis-(4,6-di-tert-butylphenyl) phosphate.

15. A phosphorescent fiber, comprising:
a core layer made of a phosphorescent masterbatch, comprising:
a phosphorescent material in a range from 1 to 50 parts by weight;
a thermoplastic polymer in a range from 43 to 98.8 parts by weight;
a dispersing agent in a range from 0.1 to 5 parts by weight; and
a nucleating agent in a range from 0.1 to 2 parts by weight; and
a sheath layer encapsulating the core layer, and a weight ratio between the core layer and the sheath layer being in a range from 10:90 to 90:10.

16. The phosphorescent fiber of claim 15, wherein the sheath layer comprises polyester, polyolefin, polyamide or combinations thereof.
